(19) United States
(12) Patent Application Publication
(10) Pub. No.: US 2004/0225536 A1
(43) Pub. Date: Nov. 11, 2004

(54) Superstructure pool computer system

(76) Inventors: Matthew B. Schoen, Ojai, CA (US); Jean-Philippe Khodara, Aix en Provence (FR); Swaminathan Palani, Stamford, CT (US)

Correspondence Address: PETER K. TRZYNA, ESQ., P O BOX 7131, CHICAGO, IL, 60680, US

(21) Appl. No.: 10/784,719

(22) Filed: Feb. 23, 2004

Related U.S. Application Data
(60) Provisional application No. 60/449,818, filed on Feb. 24, 2003.

(51) Int. Cl. G06F 17/60

(52) U.S. Cl. 705/4

(57) ABSTRACT

In the computer method variant of the invention, a computer system is programmed for adjusting participation in a pool, the method including the steps of: forming a pool to handle a monetary obligation over a period of time; storing, in a computer rules, for participation in the pool over the period of time; and using the computer to carry out the step of adjusting the participation periodically within the period of time and in accordance with the rules. In the method, the step of adjusting the participation can include changing membership in the pool, changing responsibility for the obligation respectively for a member of the pool, or both.

### I. BACKGROUND OF THE INVENTION

A. Field of the Invention

The present invention is in the field of digital electrical apparatus and method for making and using the same, as well as data structures and necessary intermediates, and articles produced thereby. More particularly, the present invention is directed to technical effects of such invention in signal processing for pool superstructure(s).

B. Background of the Invention

Life Insurance companies offer several policies that have a cash component owned by the policy owner or policyholder, often referred to as the policy cash value or cash reserve. Sometimes the cash value is immediately available to the owner in a number of ways including through policy loans, withdrawals, partial surrenders or full surrender of the policy. This is the case with most permanent life insurance policies (e.g. Whole Life, Universal life, Variable life) and with many deferred annuities. In other instances policy cash value is available only at a particular future date or as specified payments over time. This is most often the case with immediate annuities, but may also be true with certain life insurance or deferred annuity contracts.

Insurance companies may offer permanent policies under two distinct legal structures. This is true whether the policy in question is a permanent life insurance policy such as whole life or universal life policy or is a deferred or immediate annuity. The first policy structure, which has existed in the United States for over a century is a general account policy design. The second policy design, which has been in existence for less than thirty years, is a separate account policy design, or variable policy. The insurance company guarantees both the policy cash value and a minimum rate of interest under general account policies. Thus, the policy owner takes little or no direct market risk or interest rate risk with respect to policy cash value. The risk of forfeiture of cash value is specifically limited to the insolvency of the insurance company itself. That is, if the insurance company becomes insolvent, 100% of the policy cash value is at risk of being forfeited. State guarantee associations may offset a portion of the insolvency risk. In contrast, separate account policies have no guarantee of principal or returns, but policy cash value is not chargeable with any other obligations of the insurance company. In other words, the policy owner accepts the underlying market risk and or interest rate risk of the actual underlying securities held in the separate account. The assets of the separate account are subject to whatever risk is inherent in the selected investment securities, but is not subject to the claims of the insurance company's creditors in the event of its insolvency. State guarantee associations do not protect any portion of a separate account policy's cash value, unless, as described further below, one of the investment options within the separate account is an investment in the general account of the insurance company. In this instance, the extent of protection is directly commensurate with the amounts allocated to the general account investment. Generally, the assets held in the separate account are the sole source of collateral for the policyholder's policy cash value.

Some policies have attributes of each type of policy design. For example, separate account policies typically contain several investment options or divisions, typically structured as proprietary mutual funds or managed accounts. This includes various passive and or actively managed stock funds, bond funds, balanced funds, money market funds, etc. In some instances, the insurance company will also provide an option within the separate account allowing a portion of the policy cash value to be reinvested back into the general account of the insurance company. Policy cash values are entitled to the guarantees and subject to the risk inherent in traditional general account policies only to the extent that cash values are allocated to the general account option (assuming one is available at all).

During the mid-1990s, a hybrid policy was introduced, Equity Indexed Annuities (and subsequently, Equity Indexed Life Insurance Policies). The insurance companies who market Equity Indexed products consider them to be general account policies. Notwithstanding its legal structure, some state and federal regulators believe that equity index policies are more like variable policies than general account policies (i.e. despite the absence of a separate account). These regulators believe that Equity Indexed products should be subject to some of the same regulations and procedures as variable products (e.g. sold by prospectus, sold by NASD licensed registered representatives).

Despite the newness of this product, there are already numerous versions of Equity Indexed Policies on the market today. Like general account or fixed annuities, Equity Indexed annuities offer a guarantee of principal and a minimum rate of return. However, the opportunity to participate in market gains in addition to the minimum guarantees is also available with Equity Indexed Products. In this respect, Equity Indexed Annuities resemble variable annuities. The potential for upside return is tied to an external index, generally the S&P 500 Index. The percentage of the Index that the buyer is entitled to is called the participation rate. For example, if the participation rate is 85%, the Index is the S&P 500, and the Index increases 20% in a given period, than the policy owner would receive 17% growth (85% of 20%). Some plans cap or limit the upside gain in a given year. All plans offer a floor, which is typically 0% in the event Index returns are very low or negative. There are literally dozens, if not hundreds of features with these plans including the contract term (period of time the buyer must stay in the policy to receive returns, etc.), crediting methods, reset periods, etc.

Conceptually, Equity Index products (life and annuities) allow the buyer to participate in a portion of the equity market's upside, or the upside of another market index (e.g. fixed income), without being fully exposed to its downside. The insurance company acts as a buffer between the buyer and the markets. The buyer gives up a portion of the market's upside to compensate the insurance carrier for limiting the buyer's downside. The insurance company, which has greater purchasing power than most policy buyers, purchases financial derivatives to limit its losses in the event the market drops below the floor stipulated in the policy. Reinsurance may also be utilized as a means of limiting the insurer's exposure to loss.

Another mid-1990s product innovation has resulted in a hybrid separate account policy with some characteristics similar to general account policies. This concept was developed specifically to compete against general account life insurance policies purchased by banks and other institutions to fund employee benefit obligations. Banks and other businesses find that permanent life insurance is a viable means of financing long-term employee benefit obligations. Because many of these benefit obligations justify policy premiums of hundreds of millions or even billions of dollars, general account polices pose serious concentration risk (i.e. insurer insolvency risk) to the policyholder. That is, no matter how solid the financial condition of a carrier is today, it is impossible to have confidence that its financial status will remain undiminished for several years, let alone several decades to come. By substituting a highly diversified portfolio of fixed income securities within a separate account policy for the single credit risk of a general account policy, one provides immediate relief from the concentration risk associated with general account polices. Because separate account policies require the policy owner to accept all investment risk, credit-risk, interest-rate risk and the market risk associated with the underlying investment securities, GAAP accounting requires earnings to fully reflect any volatility resulting from changes in the market value of the underlying investment securities. Consequently, earnings may vacillate wildly from reporting period to reporting period according to the movement of interest rates (in the case of fixed income investments) or the stock market (in the case of equity investments). Banks and other financial institutions purchasing life insurance want stable, predictable earnings. When investing directly in fixed income investments, banks have great flexibility in selecting the applicable GAAP accounting treatment, thereby assuring stable earnings for the majority of invested assets, even in the face of constant interest rate movements. GAAP accounting for life insurance cash values follows a distinct and narrow convention under Technical Bulletin 85-4 (TB 85-4). Application of TB 85-4 generally results in volatile earnings (commonly referred to as mark-to-market accounting) under separate account policies and stable earnings under general account policies (commonly referred to as book-value or hold-to-maturity accounting). Until recently general account policies outsold separate account policies by a wide margin in the bank owned live insurance marketplace, despite the disadvantages and danger attendant to concentration risk. To date, the only method for reducing the concentration risk associated with large general account purchases was to diversify by purchasing from multiple insurance companies. This method is far from ideal, having practical limitations including: 1) There are a limited number of insurance companies that have acceptable credit ratings; 2) A much smaller number of highly rated insurance companies offer the specialized products (i.e. low-load, high cash values, guaranteed issue underwriting, etc.) for this market; 3) The terms, underwriting and administrative systems of each insurance company differs greatly, complicating valuation, monitoring and administration; 4) Purchasing from multiple insurance companies causes an otherwise unnecessary duplication of certain expenses (i.e. since each insurer charges a per policy administration fee, spreading coverage between multiple carriers increases the policy administration fee by a corresponding multiple). 5) This method of diversifying concentration risk actually increases the probability that the buyer will eventually be exposed to the insolvency of one of its insurers, 6) Increases the probability that the buyer will eventually experience price gouging or other mistreatment by an insurance company.

These risks and limitations apply equally to individual consumers seeking to reduce concentration risk. For example, consider a consumer facing a choice of where to purchase a fixed immediate annuity that must last thirty or more years to avoid financial hardship during retirement. This is in some ways analogous to a bank purchasing permanent life insurance policies it intends to own for several decades. In the case of the individual consumer, 100% of the dollars they place with a single insurance company can be forfeited or diminished materially if the insurer becomes insolvent. Even a significant downgrade in the insurance company's rating may subject the policyholder to severe psychological distress. Likewise, a bank holding significant assets within the general account of a single insurer may experience dire consequences should the insurer's credit rating drop meaningfully or if it becomes insolvent. If the consumer reduces the concentration risk by purchasing from multiple insurance companies, at what point does he/she feel satisfied with the end result? Diversifying with four separate highly rated (e.g. MA or AA rated) insurance companies may help them psychologically, but the probability of one of those four insurance companies failing is actually materially greater than any one. Is losing 25% of one's income or assets an acceptable outcome? Also, as the consumer or institution divides their overall sum of available dollars between several insurance companies, they are progressively diminishing their leverage or purchasing power while duplicating certain expenses. The net result is less income and/or growth, weakened terms and inferior underwriting—without resolving insurer insolvency risk.

During the mid-1990s a derivative financial product referred to as a stable value wrap or redemption value wrap was developed as a means of countering the undesirable earnings volatility attendant to GAAP accounting for separate account life insurance products. These “wraps” involve varying degrees of risk transfer to a wrap/financial guarantee provider, who can be the issuing insurer, a related entity or an unrelated entity. Generally, the wrap provider promises to pay the policyholder the “book value” of its portion of assets within the policy separate account in the event the policy owner surrenders the policy. The wrap provider is paid a fee for taking the risk of a negative difference between market-value and book-value at the time of surrender. The formula for crediting earnings to the policy cash value serves to build a cushion of future earnings from which the wrap provider can offset losses in the event of a policy-surrender while book-value is greater than market-value. The wrap provider is entitled to retain the difference between market-value and book-value when it is greater than book-value at surrender. Stable value wraps have enabled separate account policies to rapidly overtake general account policies as the preferred policy structure for banks and other financial institutional buyers of life insurance. A multi-billion annual business has emerged with several wrap/financial guarantee providers competing with different wrap/financial guarantee designs, features and costs. Wrap/financial guarantees have recently been developed for separate account portfolios containing non-fixed income components (e.g. equities, hedge-funds, etc.).

The use of Stable Value Wraps as a means of reducing or eliminating investment volatility pre-dates its use within institutional life insurance. It originated as a means of offering less volatile investment options to participants within 401 (k) plans and other defined contribution retirement plans. More recently, stable-value mutual funds have been developed and are available to people investing in Individual Retirement Accounts and other tax sheltered accounts. Due to the recent decline in the stock market, and the historically low returns on money market funds, stable-value mutual funds are now being developed for retail investors.

Applicant has observed that although there have clearly been some exciting recent developments in permanent policies (i.e., annuities and cash value or permanent life insurance), from the policyholder's perspective some fundamental weaknesses persist.

One weakness observed is that when buying general account policies, including Equity Indexed policies, the cash value is at risk of loss if the insurance company becomes insolvent. Given that in many instances, the policy in question is intended to be owned for several decades, this is a very difficult risk to assess, monitor or protect oneself against. State guarantee associations/funds serve as a safety net behind these policies but vary greatly from state to state. In all cases, state guarantee associations/funds are intended to primarily protect individual policy owners with smaller policies and provide little or no protection over stated upper thresholds.

Another weakness observed is that when buying separate account or variable products, the policy owner accepts market risk, credit risk and interest-rate risk of the underlying investment securities. When the policy owner selects an equity portfolio, the policy cash value changes daily according to the whims of the markets and can potentially lapse altogether in times of low or negative returns. Even 100% fixed income portfolios with low risk securities such as U.S. Treasuries are subject to potentially extreme market value fluctuations as a result of interest rate movements. Certain institutional buyers can now utilize a stable value wrap/financial guarantee or redemption value wrap to reduce the affect of interest rate risk and or market risk. In some respects, the elite, institutional insurance buyer paying hundreds of millions or even billions of dollars in premiums is not much better- off than a typical consumer who purchases a general account policy. If the wrap/financial guarantee provider becomes financially unstable or insolvent, the buyer must find a new wrap/financial guarantee provider or revert to a market value portfolio. There is no guarantee that a suitable wrap/financial guarantee provider will be available. If one is available, there is no assurance it will provide acceptable terms or charge acceptable fees.

Applicant has further observed that despite recent product innovations, policies (annuity and/or life) have yet to be developed providing the policy owner with ongoing guarantees that:

100% of the policy cash value will be protected in the event a single (i.e., avoiding the limitations and inefficiencies of purchasing multiple general account policies from multiple insurers simultaneously) insurer becomes insolvent, and;

100% of the protection provided by the wrap/financial guarantee provider(s) will continue to be provided according to the original terms, at a set cost, irrespective of the financial condition (i.e., downgrade or insolvency) of the wrap/financial guarantee provider(s).

### II. SUMMARY OF THE INVENTION

To achieve ends 1 and 2 simultaneously, Applicant has further observed that what is needed is a new product that is radically different in approach to anything that has been on the market to date. If these ends can be met simultaneously, the policyholder may obtain other material benefits as well. Within the context of a separate account policy, providing the protection goal outlined in number 1 is a given. So as long as a separate account design is deployed, the solution lies in solving the challenge posed by number 2. A single wrap/financial guarantee provider cannot solve the problem posed by number 2 because conceptually you recreate the same concentration risk associated with general account policies. Only multiple wrap/financial guarantee providers can resolve the problem.

However, as pointed out previously when describing the strategy of purchasing multiple general account insurance policies from multiple insurers, providing multiple wrap/financial guarantee providers will not necessarily assure that that the original wrap/financial guarantee terms and costs will continue to be available to the policy owner in the event one or more of the wrap/financial guarantee providers becomes financially compromised (downgraded or insolvent).

Applicant's solution resides in an overriding superstructure that governs all terms, costs and most importantly, the relative position (share of risk and revenue) of each wrap/financial guarantee provider within a plurality of wrap/financial guarantee providers according to a pre-defined, pre-agreed-to formula. The superstructure may be embodied and implemented within various forms. For example, a written agreement or other legal document specifying the rights and obligations of each wrap/financial guarantee provider within a defined pool. Irrespective of the form adopted, the governing document or entity must unambiguously determine each of the participating wrap/financial guarantee provider's fate prospectively under numerous scenarios. Consider a simplistic example of a pool comprised of three wrap/financial guarantee providers. Wrap/financial guarantee provider A is currently rated AM by pre-selected credit rating agencies. Wrap/financial guarantee provider B is rated AA by pre-selected credit rating agencies. Wrap/financial guarantee provider C is rated A+ by pre-selected credit rating agencies. The initial share of risk and revenue allocated to each wrap/financial guarantee provider must be stipulated in the legal governing agreement, along with its respective share of risk and revenue under certain triggering events in the future. For example, if any one of the wrap/financial guarantee providers is downgraded by a specified rating agency (or agencies), its share of risk and revenue is automatically adjusted according to a pre-defined formula. Depending upon the initial rating of the wrap/financial guarantee provider, the number of downgrades, or the degree of a particular downgrade, the wrap/financial guarantee provider may be automatically expelled from the pool or required to set aside a specified amount of dedicated collateral to avoid expulsion.

In the case a wrap/financial guarantee provider is expelled from the pool, withdraws voluntarily, or becomes insolvent, the agreement must stipulate in advance the share each of the remaining wrap/financial guarantee providers will inherent from the vacant slot. The agreement can also stipulate the process and terms for appointing a replacement wrap/financial guarantee provider (for a vacant slot) or for adding new slots and wrap/financial guarantee providers according to the aggregate business written or other criteria. The governing agreement can further define the type of company or entity that is eligible for each slot in the pool.

A pool can thereby make meaningful diversification distinctions between each participant. Clearly, a pool comprised of all Property Casualty Insurers or all Life Insurers or all Commercial Banks will provide less true diversification than one comprised of member(s) from each financial services category. The financial strength and integrity of a given pool design becomes a core element of its market appeal. One can conceive of almost endless combinations of pre-defined slots to optimize the overall safety of the pool i.e., diversifying according to multiple criteria, including but not limited to type of institution, type of risk ordinarily taken or exposed to, geographic dispersion of risks taken, etc.

A pool can thus be constructed that affords the policyholder the highest possible financial protection for the duration of his/her policy. This is so because the financial strength of the pool can be maintained even when certain members are severely affected by catastrophic events, losses, or exigent circumstances. The financial strength of any single provider is replaced by the efficacy of the pool itself. This can only be maintained if the governing legal agreement defines the rights, obligations and relative position of each participant of the pool over time according to an unambiguous formula and if the agreement is monitored and upheld accordingly.

The present invention includes computer aspects for the foregoing, including an article of manufacture as well as both an apparatus for carrying out the above and methods for making and using the invention, and product produced thereby. Necessary intermediates and data structures are also encompassed. In addition, some of the specific but illustrative applications for the invention are incorporated in the invention disclosure.

### III. BRIEF DESCRIPTION OF THE DRAWINGS

FIG. 1 is a representation of the present invention.

FIG. 2 is a representation of a Cn aspect of the present invention.

FIG. 3 is a representation of an Sn aspect of the present invention.

FIG. 4 is a representation of logic for a profile manager aspect of the present invention.

FIG. 5 is a representation of logic for a profile manager of a monitor candidate data aspect the present invention.

FIG. 6 is a representation of logic for a pool manager aspect of the present invention.

FIG. 7 is a representation of detailed logic for a pool manager aspect of the present invention.

FIG. 8 is a portion of detailed logic for a pool manager aspect of the present invention.

FIG. 9 is an illustration of representative structures.

### IV. DESCRIPTION OF THE PREFERRED EMBODIMENT

The monetary product (e.g., insurance, financial, etc.) approach is believed to be unique and never offered before, including the underlying end-goal of this approach is a consumer-driven model. That is, to conceive of such a structural design, one must have the consumer or end-buyer's best interests at heart. It follows that computer aspects of this novel approach are believed to be unprecedented.

The recent product developments and innovations (e.g. stable value wraps) described in this text are consistent with marketer-driven business models, and thus lead away from the approach of the present invention. That is, the prior art was born from the insurance company's desire to capture new business (or in the case of a stable value wrap, the wrap provider's desire for new business). The inherent impulse to compete against providers of similar offerings precludes one from considering the cooperative, collaborative efforts required to design a financial product or concept that is dedicated to improving the lot of the end buyer. The insurance industry has not been inspired to voluntarily pass along savings to end-consumers, unless absolutely forced to by market competition. Product expense margins have narrowed in institutional markets where competitive forces have helped to uncover all expenses, and to eliminate all but the absolutely necessary expenses. In the retail sector, greater cost efficiencies resulting from new distribution models (e.g. products sold through banks, broker-dealers and over the Internet) are either retained by the insurer or shared with distribution partners. In short, despite many recent opportunities to pass along savings and benefits to consumers, the industry on whole has resisted doing so unless forced to. Mutual Insurance companies in theory are owned by policyholders as opposed to shareholders, and should therefore pass along all available savings to policyholders. In reality, most mutual insurers have de-facto shareholders, namely their agents. To grasp the extent of impact agent distribution has on the costs of life insurance and annuity products, one can compare the policy charges of mutual insurers that relay upon agent distribution (e.g. Northwestern Mutual, New York Life, Mass Mutual) to that of policies offered by mutual insurers without agent distribution (Vanguard). It is little wonder that more and more mutual insurance companies are converting to stock corporations. The hollowness of their promise to put policyholders first is also evident in the alarming number of class-action lawsuits brought against prominent mutual insurers (and former mutual insurers) including the two largest, Met Life and Prudential. The present invention is contrary to the immediate self-interest of insurers and wrap/financial guarantee providers, especially the largest and most financially robust. The present invention's superstructure provides an immediate opportunity for smaller, lesser known insurance companies to successfully compete against the largest best known insurers. This is true whether the end- buyer is an individual or a huge institution. It is true irrespective of whether they are seeking product guarantees and characteristics of a general account product or a sophisticated wrap/financial guarantee for a separate account policy. It is true if they desire returns pegged to fixed income markets, equity markets or virtually any investment mix. They may be materially better off buying a separate account policy from a start-up insurer with a well constructed pool, than any currently available alternative, even from a highly rated industry giant. A start-up insurer can compete successfully against the largest, highest rated insurers in the United States, even in terms of the value and meaningfulness of guarantees of principal and interest or investment growth over a period of several decades.

The insurance industry and other financial services industries are familiar with pooling techniques to achieve a number of ends. For example, a reinsurance pool is a multi-reinsurer agreement whereby each reinsurer in the group assumes a specified portion of each risk ceded to the pool. Reinsurance is generally not intended to benefit the end policy owner/buyer, but rater the underwriting insurer, commonly referred to as the ceding company (because it is the company that is ceding risk to the reinsurer(s)). Generally, reinsurance, whether provided through a pool or otherwise, does not impart any direct benefit to the policy owner, even in the event of the insolvency of the ceding company. In the event of the insolvency of the ceding company, the liquidator takes control of the company and begins to collect the assets. The insolvency clause of the reinsurance treaty provides that the liquidator will receive the reinsurance proceeds on claims without reduction. The liquidator is free to use the reinsurance claims proceeds for the payment of other claims. The policyholder is not allowed to bypass the ceding company and deal directly with the reinsurer. The reinsurer is not party to any disputes between the policyholder and the ceding company. Conversely, if a reinsurance company or reinsurance pool becomes insolvent, the ceding company is not relieved of its obligations to the policyholders, even if the policies were 100% reinsured. Reinsurance is provided through a treaty, a legal agreement subject to termination or recapture of risk by the ceding company after a specified period of time. This is consistent with meeting the objectives of the insurance company and the reinsurance companies, not the policyholder. Our pooling concept is not subject to a limitation in time. It is designed to operate until its last obligation is satisfied. Pool members may be temporary, the pool is not. Also, our pooling concept is designed to specifically benefit policyholders, not only in the event of the insolvency of the issuing insurer, but also in the event any member of the pool becomes insolvent.

Because the pooling is intended to provide maximum value, utility and benefit to policyholders (or other end buyers, e.g., retail investors, financial institutions or other institutions seeking financial products such as hedges or other derivatives that ordinarily expose one or both parties to default risk), policyholders or other end-buyers can be provided with as much value as possible (e.g., highest return possible, lowest expense possible, lowest default risk possible, maximum income or other benefits possible). To that end, mathematical formulas can define profit limitations for the insurance company, counterparty and pool members. For example, marginal profit above a certain threshold can be progressively credited back to policyholders (or other end-buyers) according to a formula, not at the discretion of the insurance company counterparty, or guarantor. The pool may be structured as a mutual company to assure policyholders or other end-buyers are treated fairly on an ongoing basis. If it is not practical to organize the pool as a mutual company (e.g., many states require a large quantity of documented buyers with a demonstrated capacity and desire to purchase product before a mutual designation may be granted), a synthetic mutual company may still be formed (i.e., one that is organized with end-buyer friendly by-laws, philosophy, etc.). The members of the pool agree to provide minimum rates of returns or Stable Value, etc., whether they are organized as stock companies or mutual companies and are agreeing to treat the policyholders like participating policyholders, with a pre-defined division of profits or divisible surplus.

Such a pooling mechanism can be constructed for other long-term risks as an alternative to reinsurance or as a means of reducing counterparty default risk in hedging or derivatives transactions. Disability insurance, workers compensation and long-tem care insurance may not have a cash value component, but often pay benefits over extended periods of years. Therefore, policyholders face the risk of lost income or benefits in the event of the insurer's insolvency. If a separate account policy can be created for these types of coverage, the pooling concept can be used to improve the position of the policyholder. It may be possible to structure some other type of pool when a separate account policy can not be used or is not desirable. For example, an assumption reinsurance pool may be developed to substitute for non-separate account applications.

A variation of the concept provides similar advantages to other end-buyers (i.e., institutional and retail investors) when investing in stable-value mutual funds or other stable value investment products available within defined contribution pension plans, profit sharing plans, Individual Retirement Accounts and other tax sheltered accounts or investments.

Yet another variation on the superstructure, as another embodiment in accordance with the present invention, may be applied with equal benefits to certain long- term hedging or financial derivative transactions. Both forward contracts and futures contracts are agreements to buy or sell an asset at a future date for a certain price. Futures contracts are traded on an organized exchange, and the contract terms are standardized by that exchange. By contrast, forward contracts are private agreements between two financial institutions or a financial institution and one of its corporate clients. One of the parties to a forward contract assumes a long position and agrees to purchase an asset at a certain specified date for a certain price. The other party assumes a short position and agrees to sell the asset on the same date for the same price. Forward contracts do not have to conform to the standards of a particular exchange. The delivery date can be any date mutually agreed upon by the parties. With most forward contracts, a single delivery date is specified, whereas with futures contracts there is a range of possible delivery dates. Most futures contracts are closed out before the specified delivery date, however, most forward contracts lead to actual delivery of the physical asset or to final settlement in cash. Because forward contracts involve only two parties, often referred to as the counterparties, risk of default by one party is an inherent risk. There are several possible causes of default by either the counterparty assuming the long position or the counterparty assuming the short position. For example, a farmer promising to sell (i.e., the short position counterparty) one million bushels of corn to a buyer (i.e., the long position counterparty) under a forward agreement for a specified price may default because he is unable to produce the specified quantity due to drought or other causes or may default for bad faith because corn prices have risen dramatically since the forward contract was entered in to. By contrast, the long position counterparty may not have the requisite cash to fulfill on the purchase on the specified closing date, may have become insolvent during the intervening period, may default for bad faith (e.g., because corn prices have dropped significantly since the contract was initiated), or may default for several other reasons. A futures contract, purchased through the mechanism of an exchange, offers end buyers (both long and short position counterparties) protection against default by its corresponding counterparty. The exchange, through the use of an exchange clearinghouse, acts as an intermediary in futures transactions and guarantees the performance of the parties to each transaction. The exchange clearinghouse has a number of members, each of which has to maintain a margin account with the clearinghouse. Minimum levels of initial and maintenance margins are also required of each investor by the exchange. Futures contracts are marked to market daily by the exchange and each investor must maintain the maintenance margin or their position is closed out automatically to protect the other party. The purpose of the margining system is to reduce the possibility of market participants from sustaining losses due to defaults. The system has been very successful with losses arising from defaults in contracts at major exchanges being almost non-existent. Never the less, there are numerous situations where a futures contract is not available as a substitute for a forward contract. Treasury regulation sections 1.1221-2 and 1.446-4 (together, the “hedging rules”) define the requirements for obtaining “hedging transaction” status and the corresponding favorable tax treatment. Futures contracts by definition do not fulfill the requirements of Treasury regulation sections 1.1221-2 and 1.446-4, and therefore are not suitable as hedging transactions or for obtaining the tax treatment applicable with hedging transactions. Several options meet the hedging transaction requirements as set forth in Treasury regulation sections 1.1221-2 and 1.446-4 when structured as agreements between two counterparties. For example, forward contracts, notional principal contracts, prepaid forward contracts and certain swaps, including total return swaps, when structured properly and designated as hedging transactions as required, will fulfill the hedging rules of Treasury regulation sections 1.1221-2 and 1.446-4 and provide the desired tax treatment. In many instances the risk being hedged under such an arrangement is of a limited duration. As the duration of an agreement between two counterparties lengthens, default risk becomes more problematic. Ordinarily, counterparties have very little concern about default risk due to bankruptcy or insolvency when entering transactions with a settlement date within a relatively short (e.g., one year) time period from the agreement's effective date, especially when the counterparty in question is currently a highly rated, financially stable institution. If however, all circumstances are identical (i.e., the counterparty is presently highly rated and financially stable) except the settlement date is several years from the effective date, legitimate concerns arise regarding default risk (by reason of bankruptcy or otherwise). It is difficult if not impossible to predict the financial strength or moral integrity of an organization beyond a very limited period of time. Although fairly rare, highly rated, highly regarded financial services company have suddenly fallen into financial crises, insolvency or bankruptcy (e.g., Drexel, Burnham and Lambert, Mutual Benefit Life, Equitable Life). Additionally, in the aftermath of mergers and acquisitions, it is not uncommon for reliable managers to be replaced by less than ethical managers. Therefore, our superstructure pool concept could be used to create a hedging transaction counterparty with vastly improved long-term financial strength and integrity. Our concept provides protection against default risk to a counterparty requiring a long duration hedge. It offers some of the benefits of an organized exchange without an exchange. It offers some of the benefits of a guarantee association without a guarantee association.

In short, the pooling superstructure approach offers key benefits of an organized exchange (e.g., mitigating default risk), without the actual structure or limitations (e.g., standardized contracts) of an organized exchange while simultaneously offering some of the key protections of a state guarantee associations, without the structure or benefit limitations (e.g., benefits within separate account policies can be protected, the per policy limitations of state guarantee associations do not apply so it is possible to offer far higher amounts of protection to a policyholder at a single insurer) associated with state guarantee associations.

Turning now to the computer support, generally the invention includes computer hardware programmed for cooperation to monitor and administer one or more superstructure pools and to provide all of the requisite reporting and interfaces between all of the parties. By way of an example, consider a computer programmed for adjusting participation in a pool, including the steps of: forming a pool to handle a monetary obligation over a period of time; storing in a computer rules for participation in the pool over the period of time; and using the computer to carry out the step of adjusting the participation periodically within the period of time and in accordance with the rules. The adjusting of the participation can include at least one of: changing membership in the pool, changing responsibility for the obligation respectively for a member of the pool, changing responsibility for the obligation for the pool, and any combination thereof.

Depending on the embodiment, the number of parties bound together by such programming can be vast, even with the smallest number of pool members (two - or even one, when the pool consists of pre-approved back-up members). The system monitoring includes monitoring the pool members, preferably with direct imports from each pool member as well as several other parties (e.g., credit ratings agencies, asset valuation services, auditors, regulators). It must have the capability to provide both summary level and detailed reporting to several parties, including pool members, insurance companies, counterparties, regulators, auditors, innumerable policyholders or other owners and other interested parties. As the plurality of pool members grows, the demands on the system and the complexity of the system grows exponentially. Much of the system reporting, data processing, data storage, data retrieval of such a system can best be performed in real time, on a minute by minute basis, hourly, daily, weekly, monthly, annual and other basis.

The computer support is to handle any and preferably all of the following: respective preliminary and ongoing status of a plurality of members in a superstructure pool; each superstructure pool member's share of a specified liability, guarantee or financial product according to a plurality of pre-specified criteria and/or rules and/or formulas as may be chosen to reflect pool requirements; each superstructure pool member's share of revenues and profits; each superstructure pool member's collateral status and to compute an applicable adjustment, i.e., increase or decrease, according to a pre-specified criteria and/or rules and/or formulas as may also be chosen to reflect the pool requirements; yo apportion each superstructure pool member's share of liability, profit, etc., according to pre- specified criteria and/or rules and/or formulas as may also be chosen to reflect the pool requirements; to notify each superstructure pool member of a possible change to the status of a pool member and its consequential effect on the pool, irrespective of whether the change in status of the pool member is an improvement or deterioration; to track or monitor each superstructure pool member's adherence to pre-specified criteria and/or rules and/or formulas and to determine an action according to its findings; to track or monitor each superstructure pool member's adherence to pre-specified criteria and/or rules and/or formulas and to determine an action according to its findings based on a single component of criteria within the plurality of criteria; to track or monitor each superstructure pool member's adherence to pre-specified criteria and/or rules and/or formulas and to determine an action according to its findings based upon a combination of two or more components of criteria within the plurality of criteria; to generate reports for various parties, including each superstructure pool member, pre-approved pending superstructure pool members, regulators, end-customers, auditors and other interested parties, such reports being deliverable in hard copy, electronic file format, fax and otherwise, such reports available in virtually any file format, such reports available over the Internet and over Intranets and other computer networks; to provide automated means of calculating the price charged for the financial guarantees, hedges or financial products offered by the superstructure pool, multiple superstructure pools, or, multiple, interrelated superstructure pools.

The system of cooperating computers has respective interfaces such that action can be carried out remotely, e.g., via the Internet, intranets, and other computer networks.

Further, depending on the embodiment preferred for the application of interest, computer support can incorporate additional features and processing functions to allow for the establishment of a superstructure pool, multiple superstructure pools, or, multiple, interrelated superstructure pools based upon pre-defined terms, comprised of a plurality of legal entities agreeing to such terms while assuring that all requisite data, records and information needed to maintain such superstructure pool, multiple superstructure pools, or, multiple, interrelated superstructure pools over an extended period of time is available on a fully automated basis. Again depending on the embodiment preferred for the application of interest, computer support can extend to all the data processing and reporting necessary to monitor and report upon pool member's conformity or nonconformity to the pre-defined terms of the superstructure pool, multiple superstructure pools, or, multiple, interrelated superstructure pools. Similarly, the computer support can extend to automated tracking and reporting a change in status of any member of a superstructure pool, multiple superstructure pools, or, multiple, interrelated superstructure pools, due to the pool member's failure to conform to the pre-defined terms of the superstructure pool, multiple superstructure pools, or, multiple, interrelated superstructure pools, to a pre-defined financial goal or other milestone of the superstructure pool, multiple superstructure pools, or, multiple, interrelated superstructure pools, to the pool member's failure to conform to the pre-defined terms of the superstructure pool, multiple superstructure pools, or, multiple, interrelated superstructure pools, to the pool member conforming to a pre-defined financial goal or other milestone of the superstructure pool, multiple superstructure pools, or, multiple, interrelated superstructure pools.

Yet again, depending on the embodiment preferred for the application of interest, The computer support can extend to notifying all members of a superstructure pool, multiple superstructure pools, or, multiple, interrelated superstructure pools and other interested parties of an imminent change in the status of pool members resulting from a change in status of any member(s) of the superstructure pool, multiple superstructure pools, or, multiple, interrelated superstructure pools.

More so, depending on the embodiment preferred for the application of interest,

The present invention can encompass automated notifying, such as: notifying all members of a superstructure pool, multiple superstructure pools, or, multiple, interrelated superstructure pools and other interested parties of a change in the status of pool members resulting from a change in status of any member(s) of the superstructure pool, multiple superstructure pools, or, multiple, interrelated superstructure pools; notifying all pool members and other interested parties of an imminent change in the status of pool members resulting from a change in status of the superstructure pool, multiple superstructure pools, or, multiple, interrelated superstructure pools, in accordance with the terms of the superstructure pool, multiple superstructure pools, or, multiple, interrelated superstructure pools; notifying all members of a superstructure pool, multiple superstructure pools, or, multiple, interrelated superstructure pools and other interested parties of a change in the status of pool members resulting from a change in status of the superstructure pool, multiple superstructure pools, or, multiple, interrelated superstructure pools, in accordance with the terms of the pool.

Additionally, again depending on the embodiment preferred for the application of interest, the computer support can enable the superstructure pool, multiple superstructure pools, or, multiple, interrelated superstructure pools or other interested party to: rely upon a single digital system to perform all the data processing and reporting necessary to offer financial guarantees, hedges or financial products to insurance companies, such financial guarantees or products having life spans potentially beyond that of any single member of a superstructure pool, multiple superstructure pools, or, multiple, interrelated superstructure pools; rely upon a single digital system to perform all the data processing and reporting necessary to offer financial guarantees, hedges or financial products to financial services companies and other institutional counterparties other than insurance companies, such financial guarantees, hedges or financial products having life spans potentially beyond that of any single member of a superstructure pool, multiple superstructure pools, or, multiple, interrelated superstructure pools.

Yet additionally, again depending on the embodiment preferred for the application of interest, the computer support can enable automated digital importing and exporting capabilities, allowing data to be quickly imported, processed and exported in any system format, enable a superstructure pool, multiple superstructure pools, or, multiple, interrelated superstructure pools to offer, on a fully automated basis, financial guarantees, hedges or financial products to insurance companies that enhance the insurance companies' ability to fulfill its financial obligations to its customers, irrespective of whether the insurance company pays for the pool's financial guarantees, hedges or financial products, the policyholders pay for the financial guarantees, hedges or financial products, or such cost is shared by the insurance company and policyholder; aenable a superstructure pool, multiple superstructure pools, or, multiple, interrelated superstructure pools to offer, on a fully automated basis, financial guarantees, hedges or financial products to financial service companies other than insurance companies, which enhance the financial service companies' ability to fulfill its obligations to its customers, irrespective of whether the financial service company pays for the pool's financial guarantees, hedges or financial products, the end buyers pay for the financial guarantees, hedges or financial products, or such cost is shared by the financial service company and end buyer; enable a superstructure pool, multiple superstructure pools, or, multiple, interrelated superstructure pools to offer, on a fully automated basis, financial guarantees, hedges or financial products to financial service companies and other institutional counterparties other than insurance companies, which reduces the default risk otherwise present in such transactions. With further regard to importing, depending on the desired implementation, the present invention encompasses automatically importing case data files in any type of digital extract from another computer system, and convert it into any type of digital extract required by another party.

Also in addition, again depending on the embodiment preferred for the application of interest, the computer support can provide for automated tracking and reporting upon the financial status of all contractual obligations undertaken by the superstructure pool, multiple superstructure pools, or, multiple, interrelated superstructure pools in accordance with the terms of the superstructure pool, multiple superstructure pools, or, multiple, interrelated superstructure pools and the specific financial obligation undertaken; automated tracking and reporting upon the operational costs incurred by the superstructure pool, multiple superstructure pools, or, multiple, interrelated superstructure pools; automated tracking and reporting upon the costs incurred by the superstructure pool, multiple superstructure pools, or, multiple, interrelated superstructure pools in connection with all payments made as a result of the financial guarantees, hedges or financial products sold, undertaken or entered into; and automated tracking and reporting upon the costs incurred by the superstructure pool, multiple superstructure pools, or, multiple, interrelated superstructure pools in connection with all payments made as a result of the financial guarantees, hedges or financial products sold according to each individual contractual agreement it has entered, all of the contractual agreements it has entered, or any subset thereof.

Also in addition, again depending on the embodiment preferred for the application of interest, the computer support can facilitate automated: forecasting future costs of the superstructure pool, multiple superstructure pools, or, multiple, interrelated superstructure pools arising from the financial guarantees, hedges or financial products it offers; calculating the price charged for the financial guarantees, hedges or financial products offered by the superstructure pool, multiple superstructure pools, or, multiple, interrelated superstructure pools, irrespective of whether the insurance company pays for the financial guarantees, hedges or financial products, the policyholders pay for the financial guarantees, hedges or financial products, or such cost is shared by the insurance company and policyholder; calculating of the price charged for the financial guarantees, hedges or financial products offered by the superstructure pool, multiple superstructure pools, or, multiple, interrelated superstructure pools, irrespective of whether the financial service company pays for the pool's financial guarantees, hedges or financial products, the end buyers pay for the financial guarantees, hedges or financial products, or such cost is shared by the financial service company and end buyer; calculating a commission or other fee payable to a broker or other intermediary selling the financial guarantees, hedges or financial products offered by the superstructure pool, multiple superstructure pools, or, multiple, interrelated superstructure pools; calculating of the price charged for the financial guarantees, hedges or financial products offered by the superstructure pool, multiple superstructure pools, or, multiple, interrelated superstructure pools.

And again depending on the embodiment preferred for the application of interest, the computer support can provide automated multiple price testing modules for the financial guarantees, hedges or financial products offered by the superstructure pool, multiple superstructure pools, or, multiple, interrelated superstructure pools or contemplated to be offered by the superstructure pool, multiple superstructure pools, or, multiple, interrelated superstructure pools.

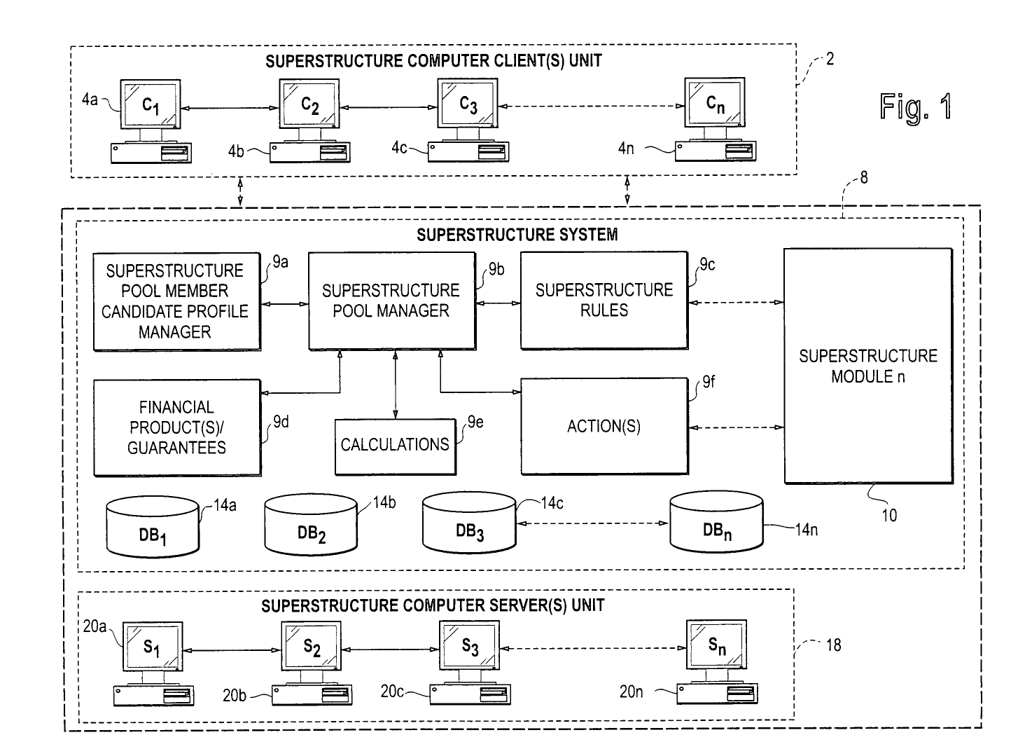

With the foregoing in mind, turn now to the Figures which illustrate a representative embodiment of the present invention, commencing with FIG. 1. Superstructure Computer Client(s) Unit 2 illustrates in diagram form possible clients to the Superstructure System. The Superstructure System may have more than one client (client logic is often analogous to candidate logic). And computer systems (programmed processor, monitor, input and output devices, as discussed below) 4a, 4b, 4c through 6 represent possible client(s) [C1-Cn] to Superstructure System. The client may handle End Customers, Brokers, Guarantors, Third Party Administrators (TPA's) and other interested parties. Each client [Cx, where x represent 1 through n] of Superstructure System may exist physically or virtually in the same geographical location or distributed in different geographical location across political boundaries around the world.

The client [Cx, where x represent 1 through n] unit 2 may receive service from Superstructure System 8 irrespective the location of either unit 2 or system 8. Requests and responses flow between unit 2 and system 8.

Superstructure System 8 includes possible module(s), such as the Candidate Profile Manager 9a, which manages new and existing candidate information. In addition to pool members, it is necessary to maintain information about potential new pool members. So for example, if a pool has an aggregate number of risk undertaken increases, the number of members sufficient to support the risk must be added. Also, as a member weakens financially, it becomes necessary to replace them with a candidate suitable to stem into the position of the replaced member. Note that the pool could have only one member, expandable as need requires (9b could be 1 member). Candidate Profile Manager 9a handles such data about candidates and future candidates.

Pool Manager 9b takes the data from Candidate Profile Manager 9a and rule data from 9c and product guarantee data from 9d to monitor and manage the pool. To illustrate, 9c can have possible governing terms, rules, criteria's, pre-defined terms, agreements etc of the Superstructure pool, and 9d can have the offerings from the pool, which may be financial products, financial guarantees etc. Calculations 9e carries out the financial calculations (e.g. price charged, price testing, commissions, fee payable, future costs forecast etc). Actions 9f handles the actions (e.g., report generation, notification, refund process, collateral adjustment, implement pre-defined rules etc).

For example, in a simple case, a pool must maintain aggregate collateral (as per a rule) in relation to aggregate risk in a given day for a given product (as per 9d). If two members in the pool have 50% share of the risk, then each is required to put up additional collateral when the need arises. This could be a daily adjustment, with timing actually depending on the volatility of the risk for the product.

Note that data flows from 9b to 9c as the rules can be a moving target and also 9b is involved in creating the pool in the first instance, as well as in monitoring and managing it. Calculations 9e can really interact in many directions and is really a multifunctional component, but in the present illustration, Pool Manager 9b communicates information about rules and product guarantees and present conditions (member and or financial) to forward to Calculations 9e. For example, minimum criteria for maintaining membership in the pool may require a certain rating, e.g., an S&P A rating. Daily monitoring may lead to automatic expulsion depending on the rules, or there may be a default such as putting up more collateral, such as 100% of the share of risk. Another possibility is for the candidate to reduce its risk. All of this is managed by System 8, with dependent or interdependent data reflecting the circumstances by which a particular pool is structured.

Calculations 92 sends data to Pool Manager 9b which controls Actions 9f in carrying out an action. Note, for example, where an action involves a choice, a client choice or candidate choice can flow back through Actions 9f.

Superstructure Module(n) 10 coordinates Actions 9f output with related any superstructure, such that action as to one pool may trigger action for another pool. This communication can be in connection with action data in and out to Client unit 2.

A plurality of databases DB1-DBn have data resident for use by the foregoing blocks 9-10. Logic can be resident in these boxes or the databases, as a matter of choice. 14a, 14b, 14c through 16 show possible database [DB1-DBn] of the Superstructure System. The database [DBx, where x represent 1 thro n] may store/retrieve Superstructure System Data. (eg. The data can be Superstructure Pool Member Candidate Profile, Pool Rules, History of Pool(s), etc). Unit 18 shows in diagram form the possible Superstructure System Server(s).

20a, 20b, 20c through 20n shows Superstructure System may reside on one or more Server [S1-Sn]. The Superstructure System Server(s) [S1-Sn] may be physically located in one geographical location or distributed across different geographical location. The geographical location of Super Structure System Server [Sx, where x represent 1 thro n] may be beyond political borders. The Client(s) 2 and/or Server(s) 18 of the Superstructure System 8 may be

programmed into a computer or electronic device that is capable of performing the functions discussed herein. Unit 18 is intended to reflect that Superstructure system 8 can reside on one, or in a different embodiment, a plurality of servers shown in unit 18, which can be in different locations, the locations being transparent to the client 2.

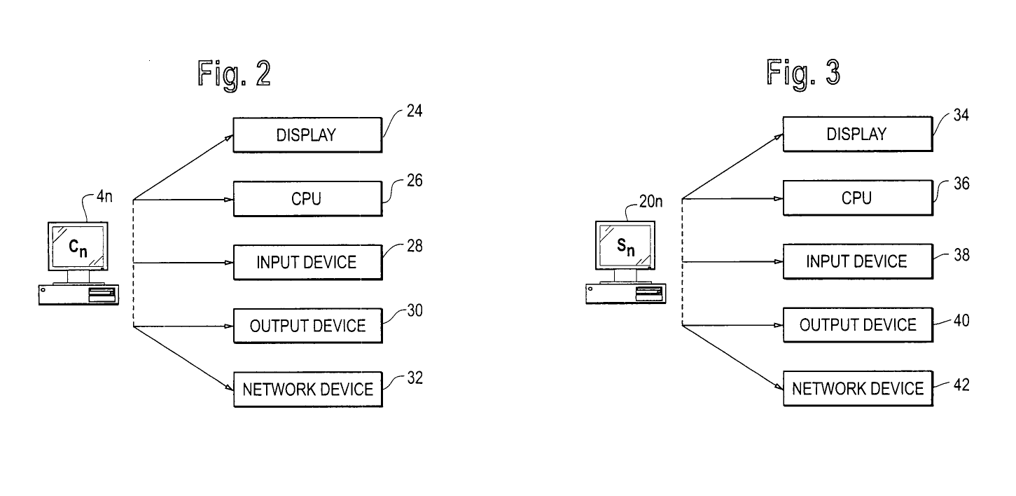

FIG. 2 shows, in block diagram form representative Client Computer Hardware for 4n. This includes a display 24 such as a Toshiba monitor, a CPU 26 such as a Intel Pentium series processor, an Input Device 28 such as a keyboard (e.g., a Hewlett Packard keyboard), an Output Device 30 such as a Hewlett Packard 8000 series printer, and a Network Device 32, such as a modem or wireless connection. Additional hardware can include secure digital cards, compact flash card, memory stick, tape devices, external hard disk, other printers, cd/dvd writers, and their equivalents.

FIG. 3 shows, in block diagram form representative Server Computer Hardware for 18. This hardware can include the corresponding hardware to that mentioned with respect to FIG. 2. That is: This includes a display 34 such as a Toshiba monitor, a CPU 36 such as a Intel Pentium series processor, an Input Device 38 such as a keyboard (e.g., a Hewlett Packard keyboard), an Output Device 40 such as a Hewlett Packard 8000 series printer, and a Network Device 42, such as a modem or wireless connection. Additional hardware can be as set forth with regard to FIG. 2. Note that often it is not necessary to connect a display unit to a server.

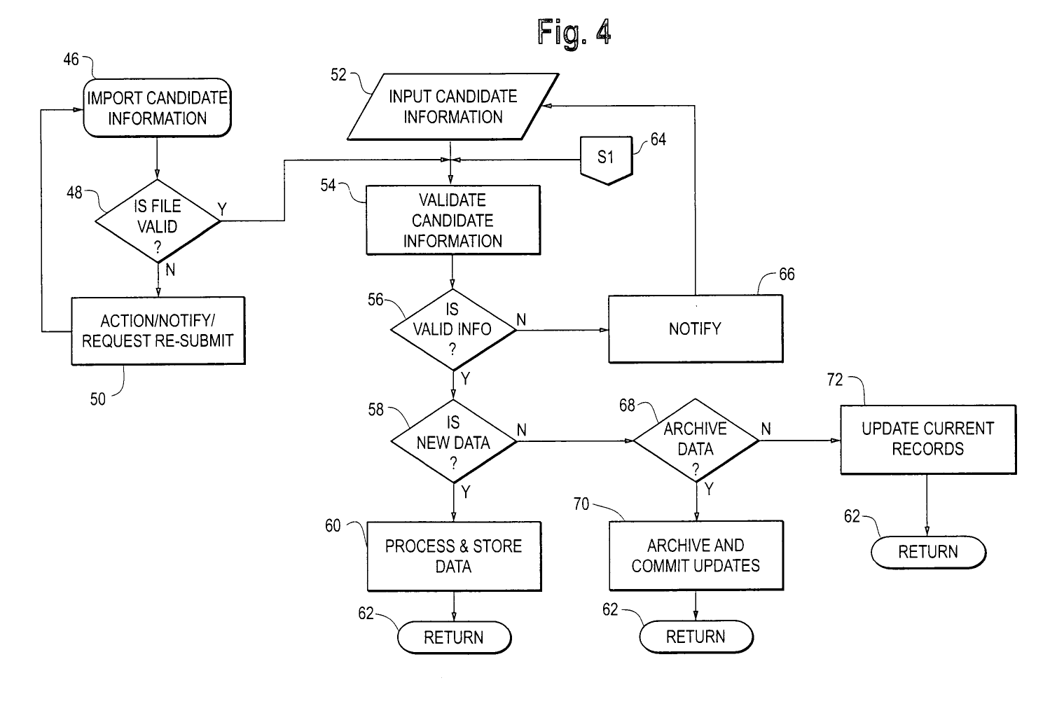

FIG. 4 shows in block diagram form a representative detailing of Superstructure Pool Member Candidate Profile Manager 9a, which manages new, existing candidate information (with the same logic applying to client information). At input information 46 imports candidate information, including importing candidate data from another computer system (or can include manually input information, as discussed below). The data being imported can be in any digital form. The information in the digital extract is converted to be processed by the system 8. Decision box 48 checks integrity of the file being imported. In box 50, if the file is corrupted/invalid format etc, notification is sent to the sender, the notification requesting data in appropriate format, etc. In box 52 the candidate information can be collected other than an import. (e.g., direct data entry such as an online form, Manual data entry). In box 54 the candidate information is validated, and decision box 56 checks all information (Info) obtained is valid. Decision box 58 checks whether the data is from new candidate or from an existing candidate who is requesting an update. In box 60 the data is from a new candidate, and the logic processes the data and stores the data in a database. Each candidate is assigned a unique identifier and stored in database. At box 62 the program loops back to 46 or 52 until all data has been captured.

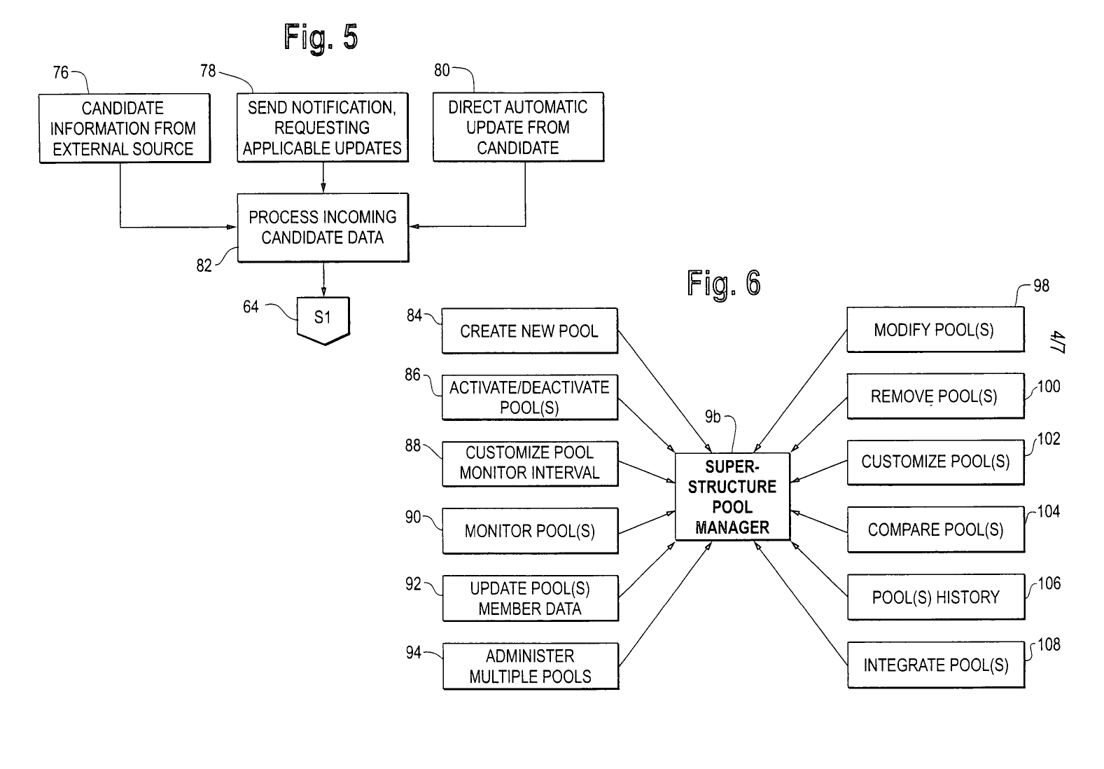

S1 64 is an off page connector: see FIG. 5.

Box 66 handles the candidate information obtained that has one or more invalid data and that cannot be stored. Notification is sent to request corrected information, along with errors and suggestions. Decision box 68 checks whether current data requires archiving. Box 70 archives current data and then commits new update. At box 62 the program loops back to 46 or 52 until all data has been captured. 72 commit updates existing candidate information, and at box 62 the program loops back to 46 or 52 until all data has been captured. FIG. 5 is a module or part of FIG. 4, with FIG. 5 showing in block diagram form monitoring Superstructure Pool Member Candidate. In box 74 the candidate information is monitored and updated at regular intervals. At box 76 reliable external source points out candidate information has changed. For example, rating agency/agencies upgrade or downgrade is imported. At box 78, another possible means of updating candidate information is to send a notification requesting applicable updates. The notification can be sent at pre-agreed intervals. At box 80 the candidate information is automatically updated at regular intervals directly from candidate by variety of means (e.g., via automated email, download, etc). At box 82 the candidate information received in different forms is processed in a way acceptable to the system. (e.g., if incoming data is an email, information contained in the email is extracted and fed to the system, or if the incoming data is a XML download, the file is validated, parsed and information contained is extracted in a way acceptable by the system.)

FIG. 6 shows in block diagram form Superstructure Pool Manager and possible modules. In box 84 the Superstructure pool manager 9b has modules to create new pool. In box 86 the Superstructure pool manager 9b has modules to activate or de-activate existing pool(s). In box 88 the Superstructure pool manager 9b has modules with which pool(s) can be scheduled to monitor at various points in time, including in real-time, hourly, daily, weekly, monthly, annually, etc. In box 90 the Superstructure pool manager 9b has modules to monitor one or more than one pool simultaneously. In box 92 the Superstructure pool manager 9b has modules that updates pool member information on a regular basis. This may be done in more than one way (e.g., scheduled automatic direct update, request sent to pool member or other parties to provide latest updates). In box 94 the Superstructure pool manager has modules to administer one or more pool(s). In box 98 the Superstructure pool manager 9b has modules to modify one or more pool(s), and in box 100 the Superstructure pool manager 9b has modules to remove one or more pool(s). In box 102 the Superstructure pool manager 9b has modules to customize pool(s), and in box 104 the Superstructure pool manager 9b has modules to analyze or compare pool(s) to produce useful statistics or other information. In box 106 the Superstructure pool manager 9b has modules that captures pool(s) activity to be retrieved, studied and processed later, and in box 108 the Superstructure pool manager 9b has modules to integrate more than one pool to form interrelated pools.

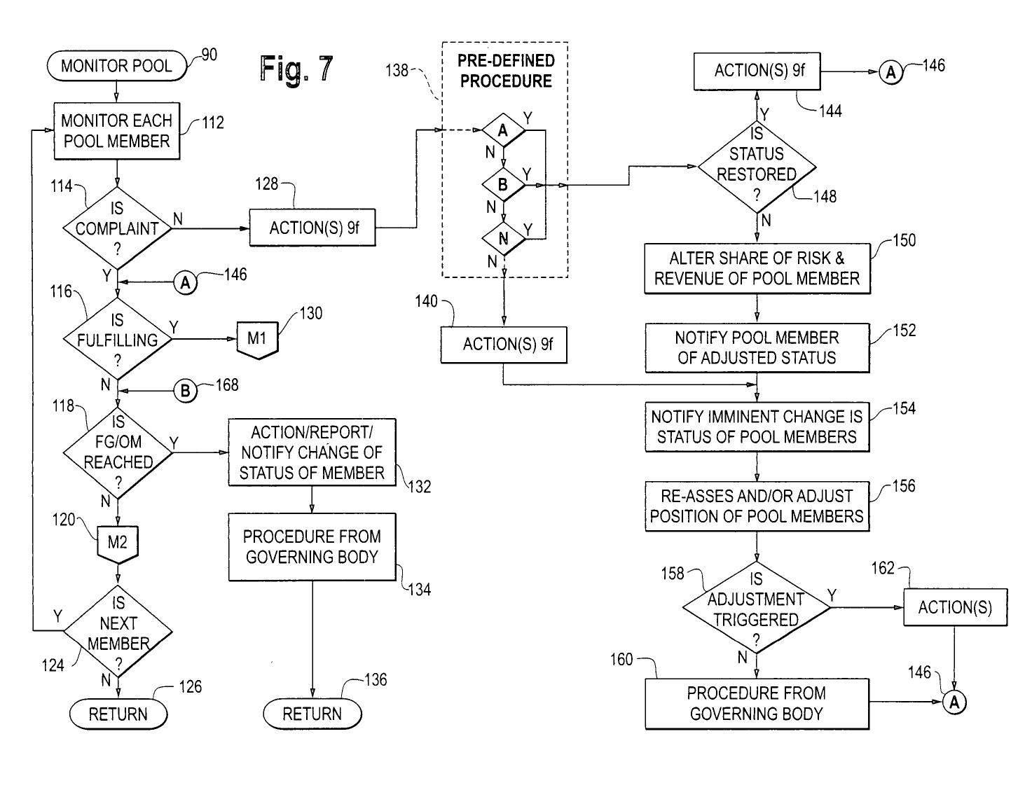

FIG. 7 shows in block diagram form pool monitoring 90 from FIG. 6, for Superstructure Pool Members; note that species are shown for the genus of Actions 9f.

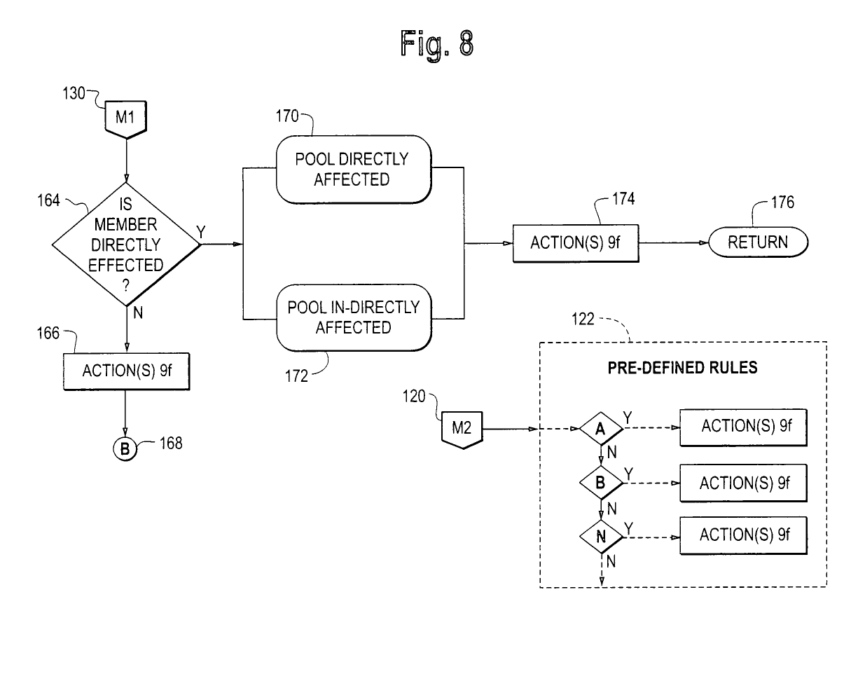

FIG. 8 shows in block diagram form a connector/continuation to diagram from. Turning to FIG. 7, box 90 starts to monitor the pool (pool can be superstructure pool, multiple superstructure pools or multiple, interrelated pools). Box 112 monitors each member in the pool, and box 114 checks for the pool member to be complaint with all pre-defined terms and other legal agreements. Box 116 checks for the pool member fulfilling new/higher standard or criteria (e.g., the pool member financial standing might have grown very strong). Box 118 checks for the pool member reached pre- defined financial goal (FG) or other milestone (OM). Box 120 is an off-page connecter, indicates diagram continued in FIG. 8. Box 122 checks the pool member for numerous other pre-defined monitoring criteria, each criteria has its action(s), and box 124 checks for remaining pool member in the pool to be monitored. Box 126 is a return to 9b after monitoring all pool members in the pool.

In box 128 (a species of Action(s) 9f) where a pool member has failed to conform to pre-defined terms, action(s) is taken (e.g., a report may be generated, an account may be debited). Report(s) may be sent to all other pool members, prospective members, regulators, auditors, end customers, counter parties and other interested parties. Reports are customizable to be brief summary or detailed.

Box 130 is an off-page connecter, indicates diagram continued in FIG. 8. In box 132 a pool member has reached pre-defined financial goals (FG) or other milestones (OM), and pre-defined action(s) take place consistent with the change in status, (e.g., collateral is increased or decreased, reports are generated, pool monitoring criteria updates). In box 134, procedures from governing body dictate next sequence of action. (e.g., the pool member has done well and achieved set milestones, now the pool member may be eligible for more risk).

136 return after implementing the procedure to 112. That is, the change in status may impact the pool itself.

Turning to box 138, a pool member non-conformity to pre-defined terms is handled, e.g., decisions a, b . . . n. The pool member is given a series of pre-agreed options. (e.g., the pool member can set aside dedicated collateral, or reduce share of risk and revenue). In box 140, a pool member non-conformity to pre-defined terms and pre-agreed options can lead to an action (species of 9f) such as being expelled from pool. (e.g., the pool member may be severely hit by catastrophe, faces significant number of claims and downgraded well below average). Note that if a pool-member is expelled from pool, pre- defined action(s) take place consistent with this change (e.g., notify other pool member(s)/other interested parties, generate report, create log).

In box 144 (species of Action(s) 9f) a pool member agrees to one or more pre-defined procedure and the status is restored to its initial, the change arising is thus notified (and also logged) to all interested parties. (e.g., the pool member may have set side dedicated collateral). Box 146 is connecter indicating the diagram is continued elsewhere on that drawing. In box 148 a pool member agrees to one or more pre-agreed options and the status is restored to its initial. In box 150, a pool member satisfied a majority of the options that entitles to lesser share of risk. The remaining share of risk and revenue gets distributed among other members according to per-defined formula(s). Box 152 sends notification to remaining pool members, and other interested parties about the change of status arising due to the pool member adjusted share of risk and revenue. Box 154 notifies all pool members and other interested parties about imminent change in status of the pool members, and in box 156, the position of the pool member is re-assessed and adjusted if necessary (e.g., the share of risk, revenue, or collateral is adjusted according to pre-defined formula(s)). Box 158 checks if adjustment trigger or risk distributed among all pool members, and in box 160, apparently the members of the pool couldn't assume remaining risk therefore the governing body intervenes. The governing body handles the situation with its procedure. In box 162, action(s) (species of Action(s) 9f) taken consistent with adjustment (e.g., notify pool members and other interested parties about the change in status arising from re-distributing the risk). 146 is a link, as discussed above.

Moving via M1 box 130 to FIG. 8, box 164 checks if pool member is directly effected, by fulfilling new/higher standard or criteria, in box 166 (species of Action(s) 9f), a pool member is not directly affected, action(s) taken. (e.g., a log is created, report is generated). Box 168 is a connector to FIG. 7. In FIG. 8, in box 170, a pool member direct effect may affect pool directly. (e.g., pool member's new higher rating may increase the overall rating of pool itself). In box 172, a pool member direct affect may affect pool in-directly. In box 174 action(s) (species of 9f) resulting from pool direct/in-direct effect is taken. (e.g., pool member(s) effect as a consequence, pool monitor criteria updates, report is generated, log is created, notification sent). In box 176 there is a return after implementing actions to 112, or if there is no action required, then 118.

From connection point 120 there is box 122 for predefined rules applied in decisions a, b . . . n, leading to actions that are also species of 9f. Each criteria has its respective action.

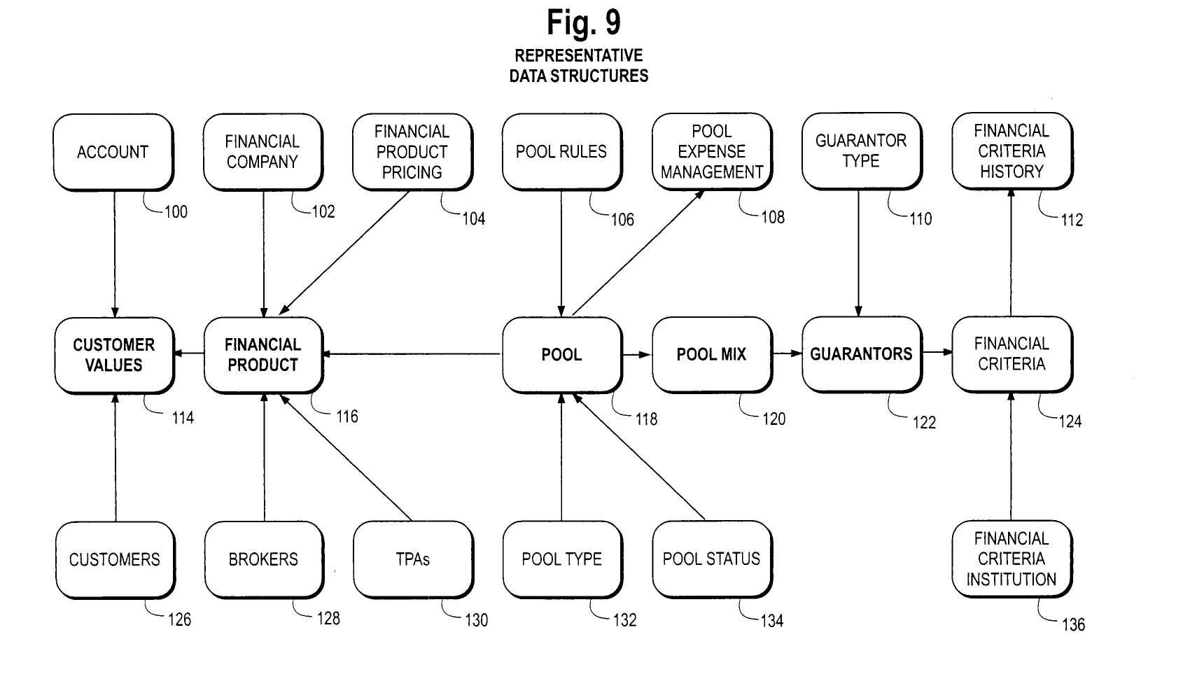

FIG. 9 shows representative data structures for the databases 14 DB(1-n) present invention, and these structured can be as shown in the table below.

Representative Table for Data Structures in FIG. 9.

| Table | | |
|---|---|---|
| ID | Table Name | Data |
| 114 | Account_Values | Account values at the customer level (account |
| | | values such as policy CSV, investment value, |
| | | including book value or guaranteed minimum |
| | | value, contingent value, market value, etc.) for |
| | | each invested account. |
| 126 | Customers | Customer information such as personal |
| | | information and investment information and |
| | | selected options. |
| 100 | Account | Investment Account such as investment |
| | | divisions, mutual funds, managed account, etc. |
| 116 | Financial_Product | Information about the financial product |
| | | purchased. |
| 102 | Financial_company | Information about the financial company |
| 128 | Brokers | Broker Information |
| 130 | TPAs | TPA information |
| 104 | Financial product pricing | All information necessary to calculate/reconcile |
| | | product charges and expenses (e.g. including |
| | | type, amount and duration of risk undertaken). |
| 118 | Pool | Pool information. |
| 106 | Pool_Rules | Pool Rules |
| 132 | Pool Type | Information about the type of pool. |
| 134 | Pool Status | Information about the pool status. |
| 108 | Pool Expense Management | Tracks, forecasts and reconciles all information |
| | | related to pool expenses including, but not |
| | | limited to financial product charges, pool |
| | | expenses, reserves, risk based capital, broker |
| | | commissions, administrative fees, profit sharing, |
| | | etc. |
| 120 | Pool_Mix | Identifies all the available guarantor slots or |
| | | positions and each respective share of the pool's |
| | | risk and rewards for a given pool. |
| 122 | Guarantors | Guarantor information. |
| 110 | Guarantor_type | Guarantor types (P&C Insurance Company, Life |
| | | Insurance Company, Commercial Bank, |
| | | Investment Bank, S&L Association, Broker |
| | | Dealer, etc.) |
| 112 | Financial_criteria_History | Rating history for all agencies for a given |
| | | guarantor. |
| 124 | Financial_criteria | Agency ratings and other financial indicators |
| 136 | Financial_Criteria_Institution | Institution or source of rating or other financial |
| | | indicators. |

Consider now an illustrative example of the present invention, with an understanding that the example is intended to teach use of the invention in a representative way, and is not intended to limit the scope of the invention to the particular example used for teaching.

Superstructure Pool Examples

Examples of Pool Level Rules

Aggregate risk undertaken by the pool determines minimum number of pool members at a given point (e.g., initial minimum number of pool members is 3, but must increase by one additional pool member as aggregate liability accepted by the pool increases by an increment of $X (e.g., $100 mm).

| Aggregate Liability | # of Members |
|---|---|
| Up to $Y | n |
| Up to $Y + $X | n + 1 |
| Up to $Y + $2X | n + 2 |
| Up to $Y + $3X | n + 3 |
| . | . |
| . | . |
| . | . |
| Up to $Y + $mX | n + m |
| . | . |
| . | . |
| . | . |

Alternatively, the number of pool members might be defined by an overall diversification optimization target or formula that may have minimum thresholds of aggregate risk governing the maximum number of members at a given point (i.e. the ultimate goal is to build a superstructure pool with a stated optimal diversification membership of 30 members—however, because establishing a pool with so many members at the outset would result in minimal profit potential (and therefore incentive) for any single pool member, aggregate risk or revenue or profit thresholds could be defined for increasing the number of pool members until the overall optimal number is achieved).

| Aggregate Liability | # of Members |
|---|---|
| Up to $Y | n |
| Up to $Y + $X | n + 1 |
| Up to $Y + $2X | n + 2 |
| Up to $Y + $3X | n + 3 |
| . | . |
| . | . |
| . | . |
| Up to $Y + $(m − n − 1)X | m − 1 |
| Over $Y + $(m − n − 1)X | m |

where m = ultimate goal number of members.

Pool must maintain a set, aggregate amount of collateral in relation to the aggregate liability exposure at a given time (thus, each member may be credited collateral contribution refunds of assessed collateral supplemental contributions daily based upon the changes to the net amount of risk, exposure, etc. Additionally, remaining pool members may be required to contribute additional collateral if a given pool member fails to meet the collateral requirement, its position is reduced by virtue of a downgrade (or other factor), or is expelled from the pool.

Aggregate Liability =$X

Collateral Requirement =$pX, where p is a percent

s₁, s₂, . . . , sₙ are the portion of the risk held by the pool members, where s₁+s₂+ . . . +sₙ=1 (or 100%)

| Participant | Amount of Collateral |
|---|---|
| 1 | s₁ × $pX |
| 2 | s₂ × $pX |
| . | . |
| . | . |
| . | . |
| n | sₙ × $pX |

If a single participant, s_{z}, has its share changed (due to any of a number of factors, including elimination from the pool), the change increases/decreases the shares of the other participants, as follows:

new sₙ=old sₙ+[(old sₙ)×(old s_{z}−new s_{z})/(1−old s_{z})]

Pool has primary participant, or anchor member that is allocated a greater overall share of the risk/profit depending upon independent set of criteria from balance of pool members. Such a mechanism may be desirable in developing countries where the anchor pool member, a domestic domiciled entity, is unable to offer a reliable product to an end consumer. The pooling mechanism is used to augment the reliability of the anchor member until such time as they have inherent reliability. The ratio of risk and profit participation between the anchor member and the balance of pool members moves over time in favor of the anchor member according to the pre-specified criteria.

The ratio of overall pool collateral to aggregate liability is a function of the overall credit rating of the pool or an average credit quality of each member.

| Overall/Average | |
|---|---|
| Credit Quality | Total Collateral |
| 1 | $aX |
| 2 | $bX |
| . | . |
| . | . |
| . | . |

where $X = aggregate liability

Examples of Participant Level Rules

Participant must contribute collateral equal to its prorated ratio of risk and/or profit participation.

Aggregate Liability=$X

Collateral Requirement=$pX, where p is a percent

s₁, s₂, . . . sₙ are the ratios of the risk and/or profit participation of the pool members, where s₁+s₂+ . . . +sₙ=1 (or 100%)

| Participant | Amount of Collateral |
|---|---|
| 1 | s₁ × $pX |
| 2 | s₂ × $pX |
| . | . |
| . | . |
| . | . |
| n | sₙ × $pX |

Participant must accept additional risk exposure (and profit participation) and collateral contribution requirements equal to its prorated share of remaining pool members in the event a pool member is expelled.

Aggregate Liability=$X

Collateral Requirement=$pX, where p is a percent

s₁, s₂, . . . , sₙ are the portion of the risk held by the pool members, where s₁+s₂+ . . . +sₙ=1 (or 100%)

s_{Z} is expelled from the pool.

New participant share is calculated as follows:

new sₙ=old sₙ+[(old sₙ)×(s_{z})/(1−s_{z})]

Participant's collateral requirement is a function of a combination of factors (prorated ratio to pool adjusted by its current credit rating by a stipulated rating agency or agencies).

The foregoing is a representative teaching of the invention. Thus, the terms and expressions which have been employed herein are used as terms of description and not of limitation, and there is no intention, in the use of such terms and expressions, of excluding equivalents of the features shown and described, or portions thereof, it being recognized that various modifications are possible within the scope of the invention, including corresponding uses in the patents and patent application incorporated by reference herein.

1. A computer method for adjusting participation in a pool, the method including the steps of:
forming a pool to handle a monetary obligation over a period of time;
storing, in a computer rules, for participation in the pool over the period of time; and
using the computer to carry out the step of adjusting the participation periodically within the period of time and in accordance with the rules.

2. The method of claim 1, wherein the step of adjusting the participation includes changing membership in the pool.

3. The method of claim 1, wherein the step of adjusting the participation includes changing responsibility for the obligation respectively for a member of the pool.

4. The method of claim 1, wherein the step of adjusting the participation includes changing responsibility for the obligation for the pool.
